(19) United States
(12) Patent Application Publication
(10) Pub. No.: US 2012/0233143 A1
(43) Pub. Date: Sep. 13, 2012

(54) IMAGE-BASED SEARCH INTERFACE

(76) Inventor: James R. Everingham, Santa Cruz, CA (US)

(21) Appl. No.: 13/398,700

(22) Filed: Feb. 16, 2012

Related U.S. Application Data
(63) Continuation of application No. 13/045,426, filed on Mar. 10, 2011.

(51) Int. Cl. G06F 17/30

(52) U.S. Cl. 707/706; 707/769; 707/E17.108; 707/E17.03

(57) ABSTRACT

Systems and method for providing an image-based search interface. In one embodiment, for example, there is provided a method comprising displaying an image, and upon a user's activation of the image, presenting to the user a pre-populated search interface. There is also provided an image processing method for providing a web user with a pre-populated search interface, comprising: (a) receiving an image from a source; (b) analyzing the image to identify the subject matter within the image; (c) generating a search tag based on the subject matter within the image; and (d) sending the search tag to the source. In one embodiment, the systems and methods described herein are used in computer-implemented advertising.

### CROSS-REFERENCE TO RELATED APPLICATIONS

This application is a continuation of U.S. patent application Ser. No. 13/045,426, filed on Mar. 10, 2011, which is incorporated herein by reference in its entirety.

### SUMMARY

Disclosed herein are systems and method for providing an image-based search interface. In one embodiment, for example, there is provided a method comprising displaying an image and, upon a user's activation of the image, presenting to the user a pre-populated search interface. There is also provided an image processing method for providing a web user with a pre-populated search interface, comprising: (a) receiving an image from a source; (b) analyzing the image to identify the subject matter within the image; (c) generating a search tag based on the subject matter within the image; and (d) sending the search tag to the source. In one embodiment, the systems and methods described herein are used in computer-implemented advertising.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level diagram illustrating the relationships between the parties that partake in the presented systems and methods.

FIG. 2 is a flowchart illustrating a method in accordance with one embodiment presented herein.

FIG. 3 is a flowchart illustrating a method in accordance with one embodiment presented herein.

FIG. 4 is a flowchart further illustrating the steps for performing an aspect of the method described in FIG. 3.

FIG. 5 is a flowchart illustrating a method in accordance with an alternative embodiment presented herein.

FIG. 6 is a schematic drawing of a computer system used to implement the methods presented herein.

FIGS. 7A and 7B are an exemplary user-interface in accordance with one embodiment presented herein.

FIGS. 8A and 8B are an exemplary user-interface in accordance with one embodiment presented herein.

FIGS. 9A and 9B are an exemplary user-interface in accordance with another embodiment presented herein.

FIGS. 10A and 10B are an exemplary user-interface in accordance with still another embodiment presented herein.

FIGS. 11A and 11B are an exemplary user-interface in accordance with one embodiment presented herein.

FIGS. 12A-12C are still another exemplary user-interface in accordance with one embodiment presented herein.

### DEFINITIONS

Prior to describing the present invention in detail, it is useful to provide definitions for key terms and concepts used herein.

Ad server: One or more computers, or equivalent systems, which maintains a database of creatives, delivers creative(s), and/or tracks advertisement(s), campaign(s), and/or campaign metric(s) independent of the platform where the advertisement is being displayed.

“Advertisement” or “ad”: One or more images, with or without associated text, to promote or display a product or service. Terms “advertisement” and “ad,” in the singular or plural, are used interchangeably.

Advertisement creative: A document, hyperlink, or thumbnail with advertisement, image, or any other content or material related to a product or service.

Connectivity query: Is intended to broadly mean “a search query that reports on the connectivity of an indexed web graph.”

Crowdsourcing: The process of delegating a task to one or more individuals, with or without compensation.

Document: Broadly interpreted to include any machine-readable and machine-storable work product (e.g., an email, a computer file, a combination of computer files, one or more computer files with embedded links to other files, web pages, digital image, etc.).

Informational query: Is intended to broadly mean “a search query that covers a broad topic for which there may be a large number of relevant results.”

Navigational query: Is intended to broadly mean “a search query that seeks a single website or web page of a single entity.”

Proximate: Is intended to broadly mean “relatively adjacent, close, or near,” as would be understood by one of skill in the art. The term “proximate” should not be narrowly construed to require an absolute position or abutment. For example, “content displayed proximate to a search interface,” means “content displayed relatively near a search interface, but not necessarily abutting or within a search interface.” In another example, “content displayed proximate to a search interface,” means “content displayed on the same screen page or web page as a search interface.”

Syntax-specific standardized query: Is intended to broadly mean “a search query based on a standard query language, which is governed by syntax rules.”

Transactional query: Is intended to broadly mean “a search query that reflects the intent of the user to perform a particular action,” e.g., making a purchase, downloading a document, etc.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### DETAILED DESCRIPTION

The present invention generally relates to computer-implemented search interfaces (e.g., Internet search interfaces). More specifically, the present invention relates to systems and methods for providing an image-based search interface.

In a typical search interface, a user provides a search engine (or query processor) with a search query (or search string) in the form of text. The search engine then uses keywords, titles, and/or indexing to search the Internet (or other database or network) for relevant documents. Links (e.g., hyperlinks or thumbnails) are then returned to the user in order to provide the user with access to the relevant documents. The methods and systems presented below provide a pre-populated search interface, based on a displayed image, that can redirect a web user to a search engine, provide an opportunity to influence the user's search, and provide an opportunity to advertise to the user.

For example, in one embodiment, there is provided a computer-implemented method. The method includes displaying an image (e.g., a digital image on a web page) and, upon a user's activation of the image (e.g., the user mouse-over the image), providing a pre-populated search interface. For example, the search interface may be “pre-populated” with one or more search tags based on the subject matter (or objects) within the image. In alternative embodiments contextually relevant content can be generated based on the subject matter (or objects) within the image. The contextually relevant content may include: a hyperlink, an advertisement creative, content specific advertising, content specific information, Internet search results, images, text, etc. The contextually relevant content can be displayed proximate to the search interface.

In another embodiment, there is provided an image processing method for providing a web user with a pre-populated search interface, comprising: (a) receiving an image from a source; (b) analyzing the image to identify the subject matter within the image; (c) generating a search tag based on the subject matter within the image; and (d) sending the search tag to the source. The method may further comprise: (1) identifying positional information of a first object in the image; (2) generating a first search tag based on the first object; (3) linking the positional information of the first object to the search tag based on the first object; (4) identifying positional information of a second object in the image; (5) generating a second search tag based on the second object; (6) linking the positional information of the second object to the search tag based on the second object; and/or (7) sending the first search tag and the second search tag, and respective positional information, to the source. Steps (b) and/or (c) may be automatically performed by a computer-implemented image recognition engine, or may be performed by crowdsourcing. The search tag may be an informational query, a navigational query, a transactional query, a connectivity query, a syntax-specific standardized query, or any equivalent thereof. The search tag may be in the form of a “natural language” or may be in the form of a computer-specific syntax language. The search tag may also be content specific or in the form of an alias tag. The search tag is then used to pre-populate the search interface. In one embodiment, the image is analyzed upon a user's activation of the image (e.g., a mouse-over event). In another embodiment, the image is analyzed before initial display. In one embodiment, the search tag is sent to the source upon a user's activation of the image (e.g., a mouse-over event). In another embodiment, the search tag is associated with the image before initial display.

The method may further include generating contextually relevant content based on the search tag, and sending the contextually relevant content to the source. The contextually relevant content may then be displayed proximate to the search interface. The contextually relevant content may be selected from the group consisting of: an advertisement creative, a hyperlink, text, and an image. The contextually relevant content may more broadly include content such as: a hyperlink, an advertisement creative, content specific advertising, content specific information, Internet search results, images, and/or text. The method may further include conducting an Internet search based on the search tag, and sending the Internet search results to the source. The Internet search results may then be displayed proximate to the search interface.

The following detailed description of the figures refers to the accompanying drawings that illustrate exemplary embodiments. Other embodiments are possible. Modifications may be made to the embodiments described herein without departing from the spirit and scope of the present invention. Therefore, the following detailed description is not meant to be limiting.

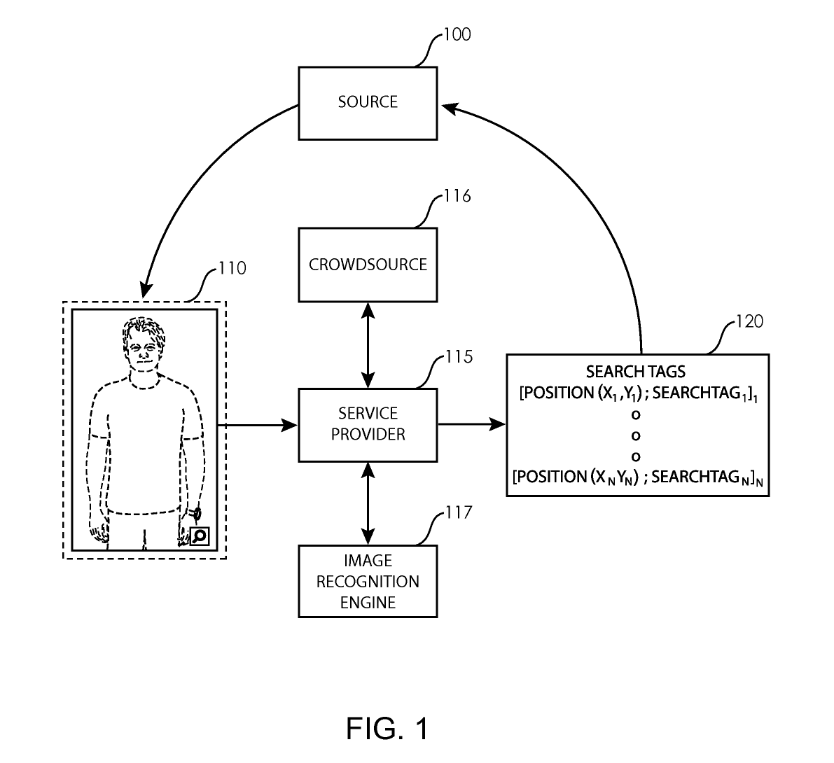

FIG. 1 is a high-level diagram illustrating the relationships between the parties/systems that partake in the presented methods. In operation a source 100 provides an image 110 to a service provider 115. As further described below, source 100 engages/employs service provider 115 to convert image 110 into a dynamic image that can be provided or displayed to an end-user (e.g., a web user) with an image-based search interface. In one embodiment, source 100 is a web publisher. In other embodiments, however, source 100 may be any automated or semi-automated digital content platform, such as a web browser, website, web page, software application, mobile device application, TV widget, ad server, or equivalents thereof. As such, the term “source” should be broadly construed to mean any party, system, or unit that provides image 110 to service provide 115. Image 110 may be “provided” to service provider 115 in a push or pull fashion. Further, service provider 115 need not be an entity distinct from source 100. In other words, source 100 may perform the functions of service provider 115, as described below, as a sub-protocol to the typical operations of source 100.

After receiving image 110 from source 100, service provider 115 analyzes image 110 with input from a crowdsource 116 and/or an automated image recognition engine 117. As will be further detailed below, crowdsource 116 and/or image recognition engine 117 analyze image 110 to generate search tags 120 based on the subject matter within the image. To the extent that image 110 includes a plurality of objects within the image, crowdsource 116 and/or image recognition engine 117 generate a plurality of search tags 120 and positional information based on the objects identified in the image. Search tags 120 are then returned to source 100 and properly associated with image 110.

Image recognition engine 117 may use any general-purpose or specialized image recognition software known in the art. Image recognition algorithms and analysis programs are publicly available; see, for example, Wang et al., “Content-based image indexing and searching using Daubechies' wavelts,” Int J Digit Libr (1997) 1:311-328, which is herein incorporated by reference in its entirety.

Source 100 can then display the image to an end-user. In one embodiment, when the end-user activates the image (e.g., a web user may mouse-over the image), a search interface can be provided within or proximate to the image. The search interface can be pre-populated with the search tag. The end-user can then activate the search interface and be automatically redirected to a search engine, where an Internet search is conducted based on the pre-populated search tag. In one embodiment, the end-user can be provided with an opportunity to adjust or modify the search tag before a search is performed.

In an embodiment wherein multiple objects are identified within the image, each object can be linked to positional information identifying where on the image the object is located. Then, when the image is displayed to the end-user, the end-user can activate different areas of the image in order to obtain different search tags based on the area that has been activated. For example, image 110 of FIG. 1 may be analyzed by service provider 115 (with input from crowdsource 116 and/or image recognition engine 117) to identify the objects within the image and generate the following search tags: [James Everingham, Position (X₁, Y₁); BRAND NAME Shirt, Position (X₂, Y₂); and BRAND NAME Watch, Position (X₃, Y₃)]. These search tags can then be linked to image 110 and returned to source 100. If an end-user activates position (X₁, Y₁), by for example a mouse-over of the subject, then a search interface may be provided with the pre-populated search tag “James Everingham.” If an end-user activates position (X₂, Y₂), by for example a mouse-over of the subject's shirt, a search interface may be provided with the pre-populated search tag “BRAND NAME Shirt.” If an end-user activates position (X₃, Y₃), by for example a mouse-over of the subject's watch, then a search interface may be provided with a pre-populated search tag “BRAND NAME Watch.” Such “pre-populating” of the search interface can generate interest in the end-user to conduct further search, and may ultimately lead the end-user to make a purchase based on the search. As such, the presented systems and methods may be employed in a computer-implemented advertising method.

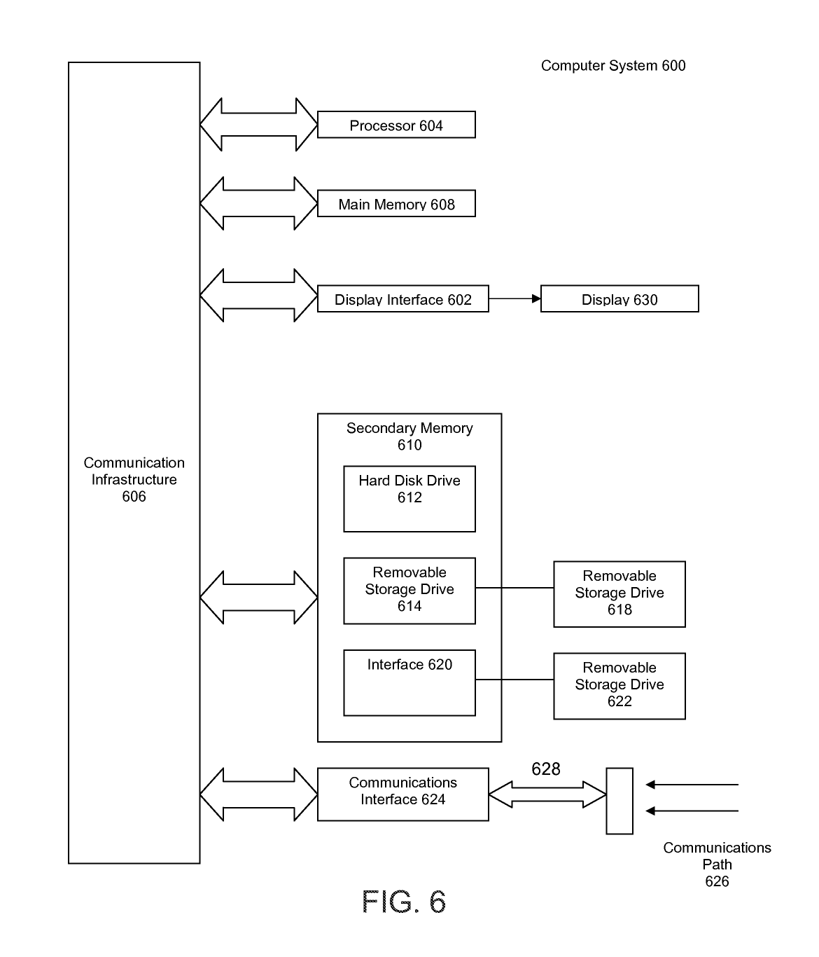

In one embodiment, communication between the various parties and components of the present invention is accomplished over a network consisting of electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto. The functionality and system components of an exemplary computer and network are further explained in conjunction with FIG. 6, below.

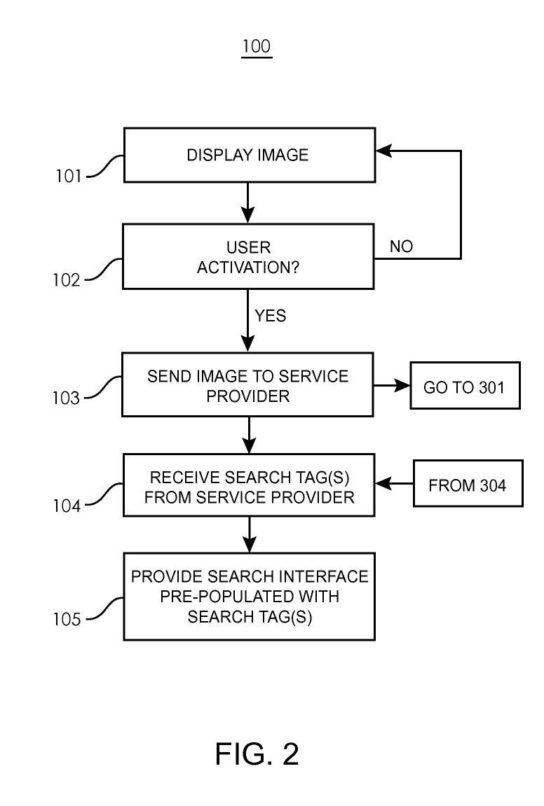

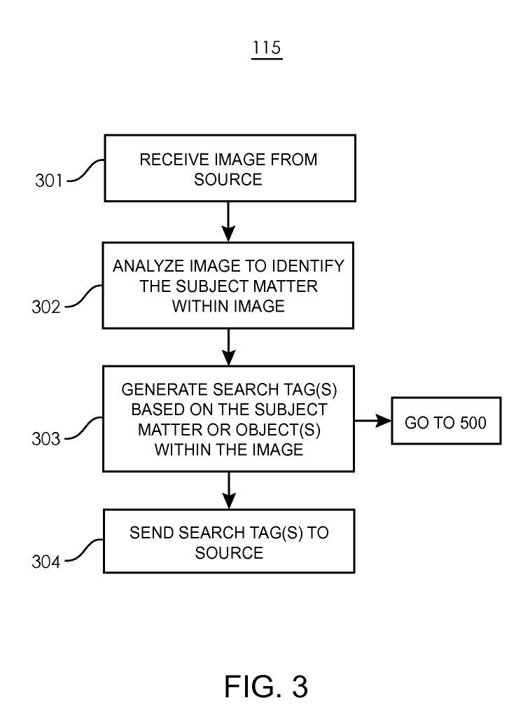

FIG. 2 is a flowchart illustrating a method, in accordance with one embodiment presented herein. In one embodiment, the method outlined in FIG. 2 is performed by source 100. In step 101, an image is displayed to an end-user. For example, a source, such as a web page publisher, can display a digital image to a web user on a website. In another example, a source, such as a mobile application, can display a digital image to a mobile application user. In step 102, a determination is made as to whether the user has activated the image. For example, a user activation may be a web user mouse-over of the image, or a mobile application user touching the image on the mobile device screen, or any end-user activation equivalent thereto. If the end-user does not activate the image, then the image can continue to be displayed. However, if the end-user activates the image, then the goal of the source is to ultimately provide a search interface pre-populated with a search tag based on the image, as in step 105. To this end, source 100 performs step 103 (i.e., send image to service provider, see method step 301 in FIG. 3) and step 104 (i.e., receive search tag(s) from service provider, see method step 304 in FIG. 3). In one embodiment, steps 103 and 104 are performed only after user-activation of the image. In an alternative embodiment, steps 103 and 104 are performed with or without user-activation of the image.

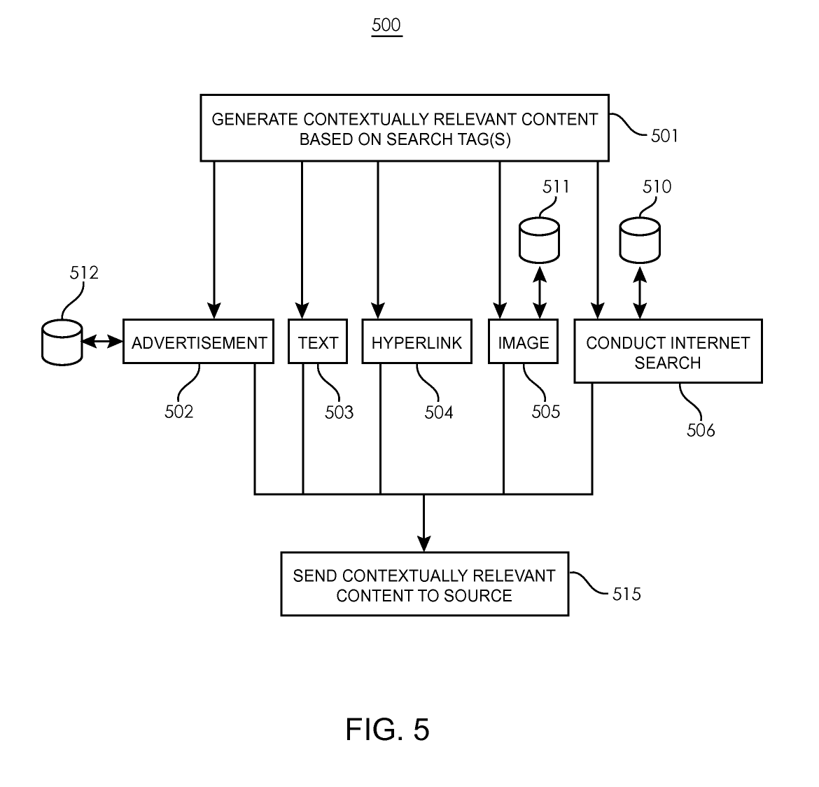

FIG. 3 is a flowchart illustrating a method in accordance with one embodiment presented herein. In one embodiment, the method outlined in FIG. 3 is performed by service provider 115. In step 301, an image is received from a source. In step 302, the image is analyzed to identify the subject matter within the image. In step 303, search tag(s) are generated based on the subject matter or objects within the image. In one embodiment, method 500 (see FIG. 5) is performed in parallel to step 303. In step 304, the search tag(s) are sent to the source. Such search tag(s) become the basis for the pre-populated search interface.

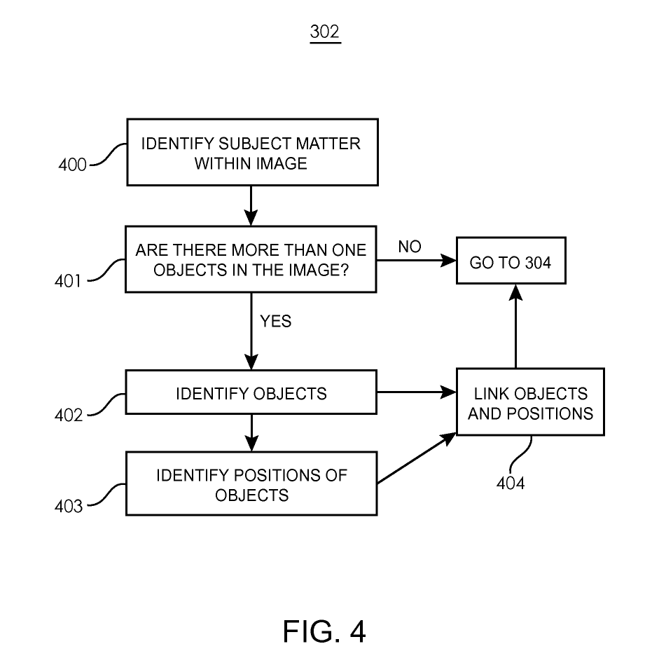

FIG. 4 is a flowchart further illustrating step 302, in one embodiment, of FIG. 3. In step 400, a crowdsource 116 and/or image recognition engine 117 is used to identify the subject matter within the image. In step 401, a determination is made as to whether there are multiple objects of interest in the image. If so, the objects are each individually identified in step 402. Further, the relative position of each object is identified in step 403. In step 404, the objects and their respective position are linked. The identified objects then form the basis of the search tag(s) that are sent to the source in step 304.

FIG. 5 is a flowchart illustrating a method 500, in accordance with an alternative embodiment presented herein. In step 501, contextually relevant content is generated based on the search tag(s). The contextually relevant content may broadly include content such as: an advertisement creative 502 or content specific advertising pulled from an ad server 512; text 503 with content specific information; a hyperlink 504; images 505 pulled from an image database 511; Internet search results 506 pulled from an Internet search of relevant database(s) 510; or the like. The contextually relevant content is then sent to the source, in step 515, for display proximate to the pre-populated search interface.

### Example User-Interfaces.

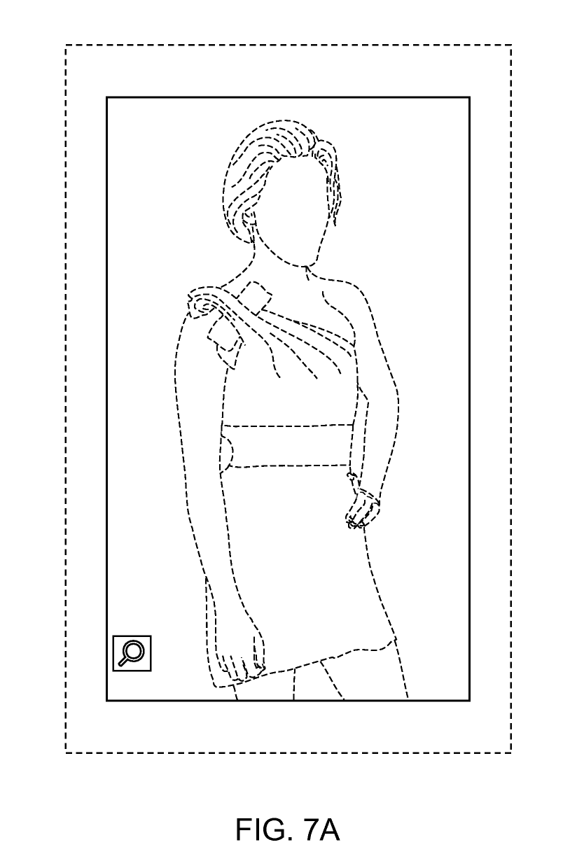

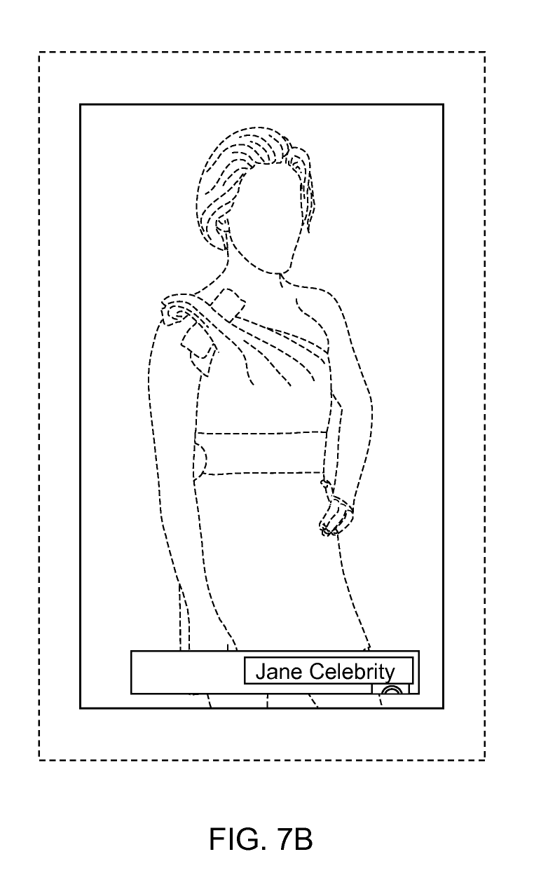

FIGS. 7A and 7B are an exemplary user-interface in accordance with one embodiment presented herein. FIG. 7A shows an image being displayed by the source. As shown, an icon (such as a magnifying glass or other indicia) can be provided on the image to give the end-user the option to activate the image. When the end-user activates the image (e.g., mouse-over the magnifying glass) a pre-populated search interface is provided, such as shown in FIG. 7B. The end-user can then modify the pre-populated search interface, or simply accept the pre-populated search interface, and use the search interface to conduct an Internet search of the subject matter within the image.

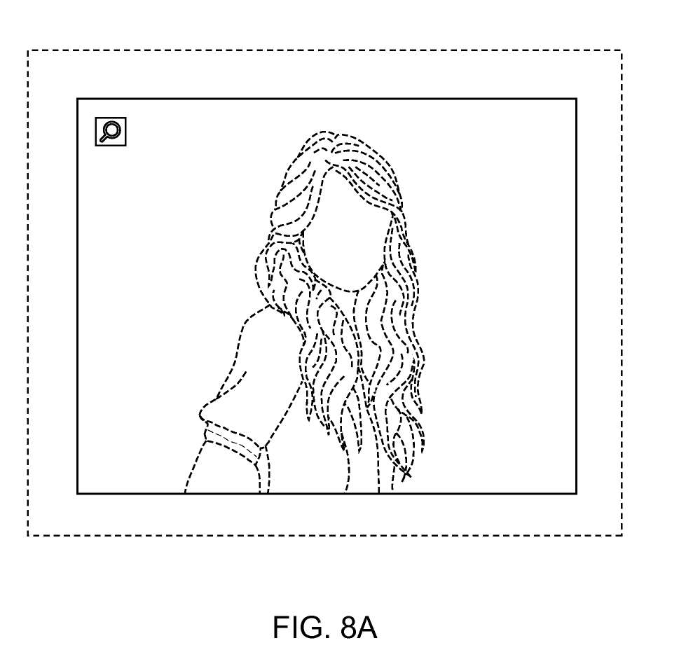

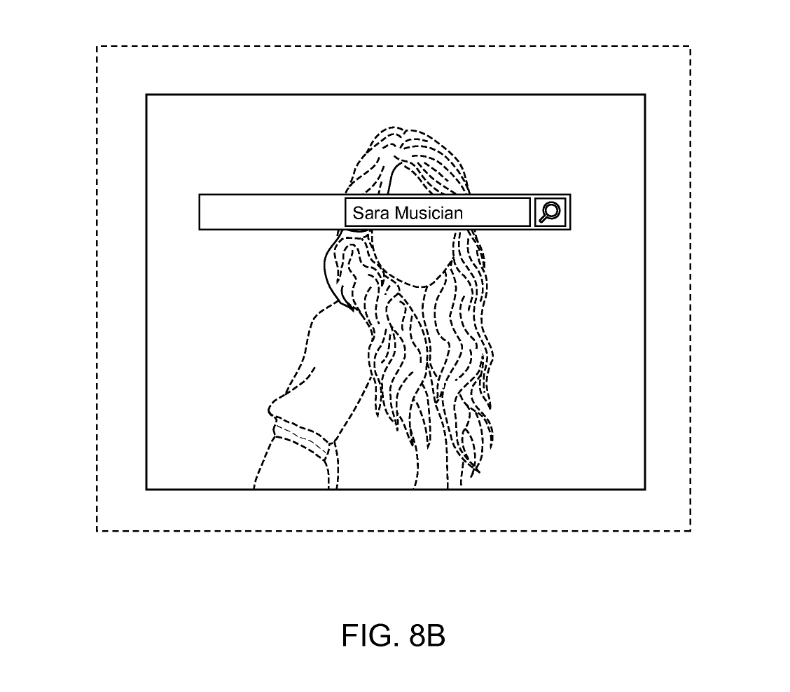

FIGS. 8A and 8B are another exemplary user-interface in accordance with one embodiment presented herein. FIG. 8A shows an image being displayed by the source. As shown, an icon (such as a magnifying glass or other indicia) can be provided on the image to give the end-user the option to activate the image. When the end-user activates the image (e.g., mouse-over the magnifying glass) a pre-populated search interface is provided, such as shown in FIG. 8B. The end-user can then modify the pre-populated search interface, or simply accept the pre-populated search interface, and use the search interface to conduct an Internet search of the subject matter within the image.

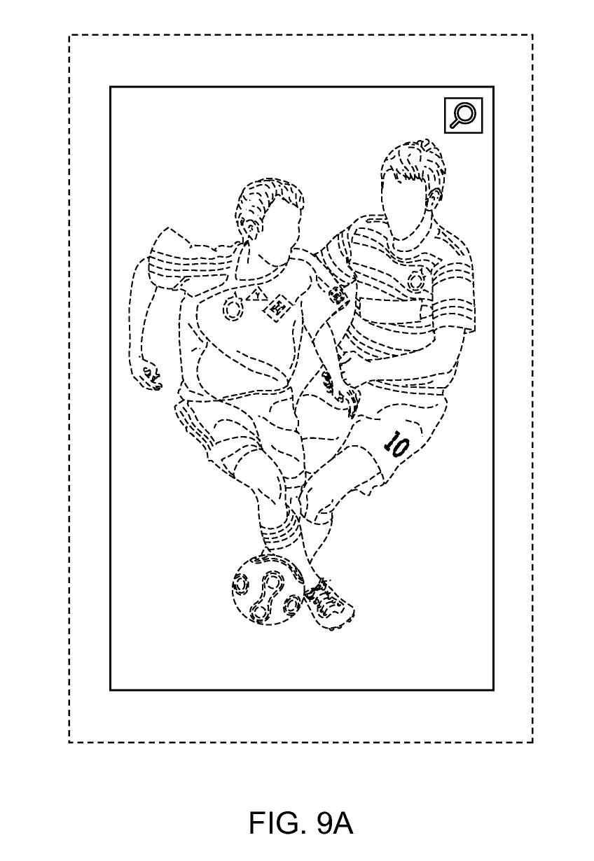

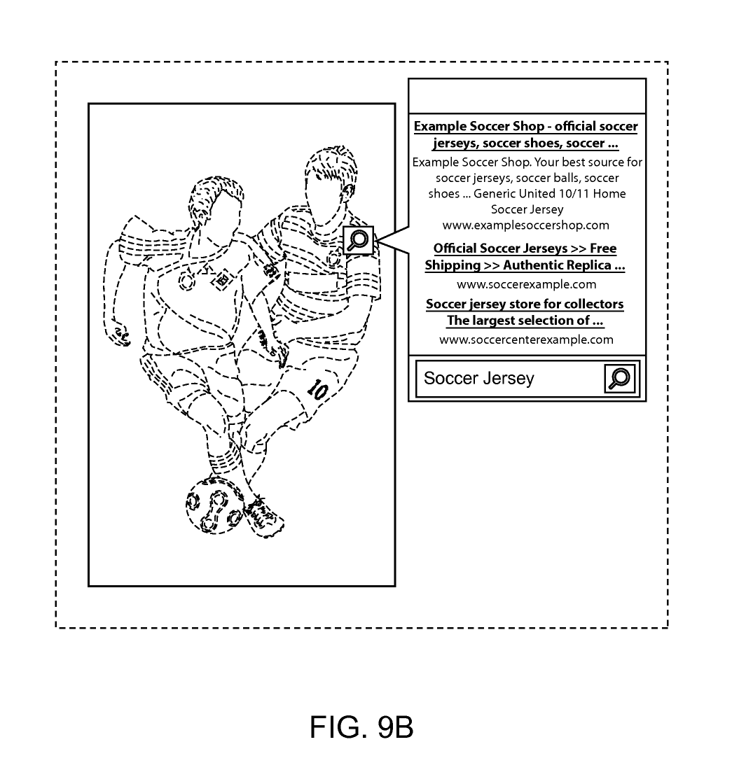

FIGS. 9A and 9B are yet another exemplary user-interface in accordance with one embodiment presented herein. FIG. 9A shows an image being displayed by the source. As shown, an icon (such as a magnifying glass or other indicia) can be provided on the image to give the end-user the option to activate the image. When the end-user activates the image (e.g., mouse-over the magnifying glass) a pre-populated search interface is provided, such as shown in FIG. 9B. The end-user can then modify the pre-populated search interface, or simply accept the pre-populated search interface, and use the search interface to conduct an Internet search of the subject matter within the image. FIG. 9B also shows how contextually relevant content can also be provided proximate to the pre-populated search interface.

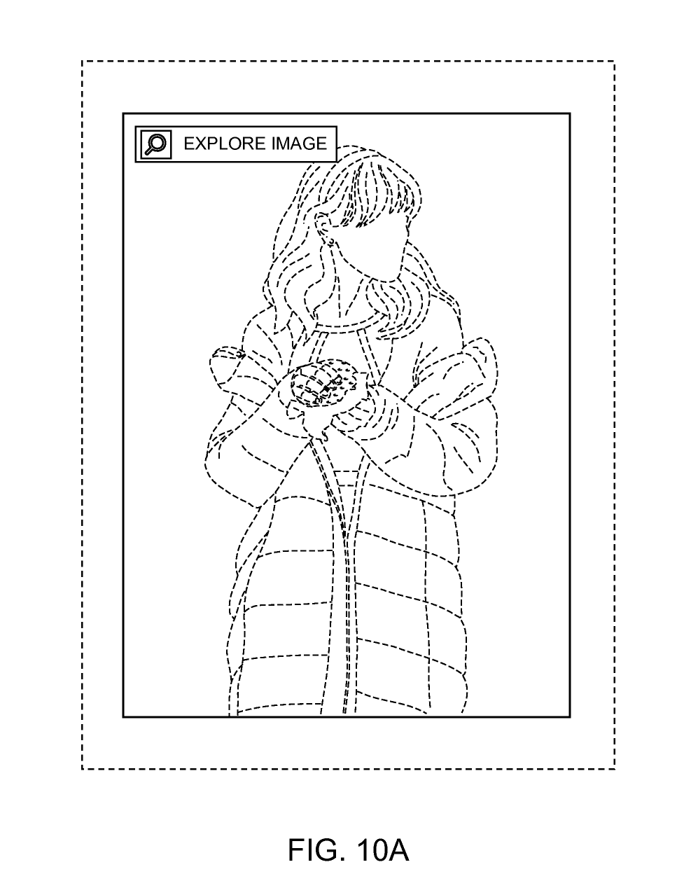

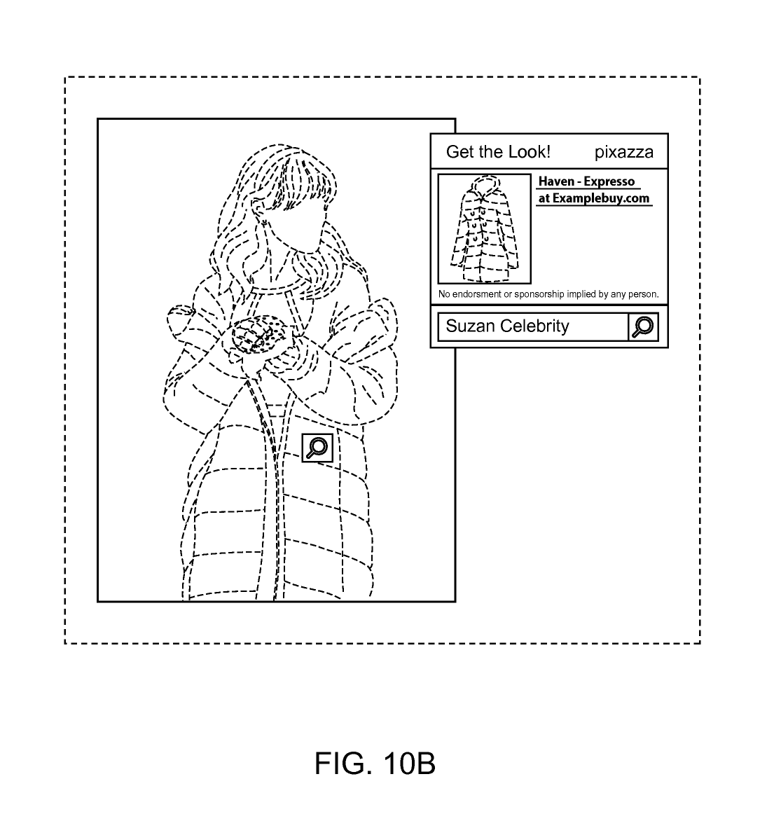

FIGS. 10A and 10B are another exemplary user-interface in accordance with one embodiment presented herein. FIG. 10A shows an image being displayed by the source. As shown, an icon (such as a magnifying glass or other indicia) can be provided on the image to give the end-user the option to activate the image. When the end-user activates the image (e.g., mouse-over the magnifying glass) a pre-populated search interface is provided, such as shown in FIG. 10B. The end-user can then modify the pre-populated search interface, or simply accept the pre-populated search interface, and use the search interface to conduct an Internet search of the subject matter within the image. FIG. 10B also shows how contextually relevant content, such as an advertisement creative, can also be provided proximate to the pre-populated search interface.

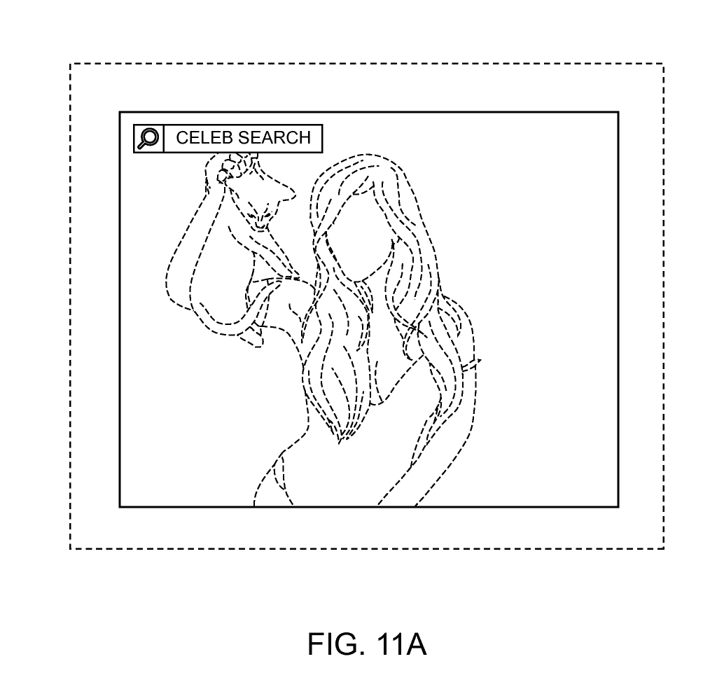

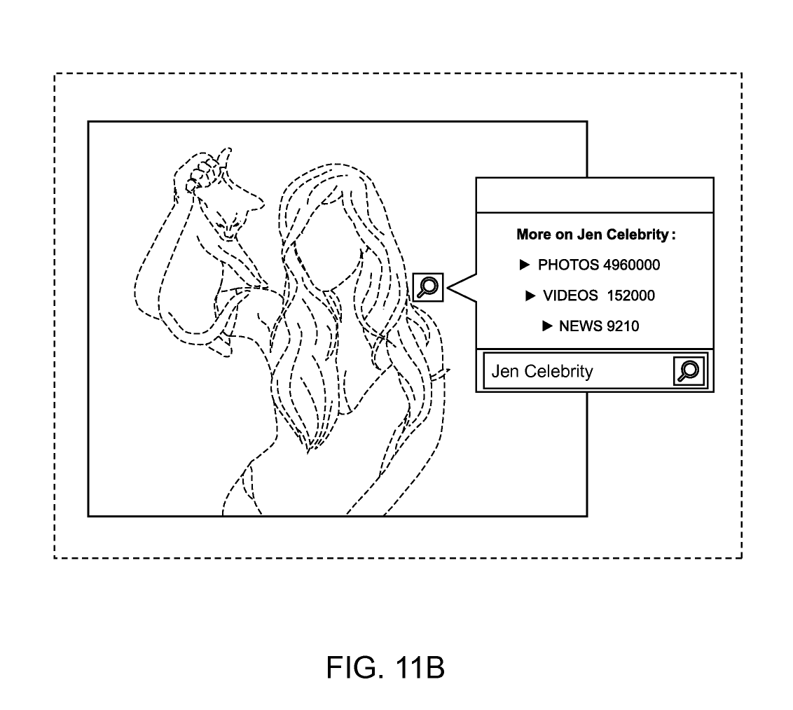

FIGS. 11A and 11B are still another exemplary user-interface in accordance with one embodiment presented herein. FIG. 11A shows an image being displayed by the source. As shown, an icon (such as a magnifying glass or other indicia) can be provided on the image to give the end-user the option to activate the image. When the end-user activates the image (e.g., mouse-over the magnifying glass) a pre-populated search interface is provided, such as shown in FIG. 11B. The end-user can then modify the pre-populated search interface, or simply accept the pre-populated search interface, and use the search interface to conduct an Internet search of the subject matter within the image. FIG. 11B also shows how contextually relevant content can also be provided proximate to the pre-populated search interface.

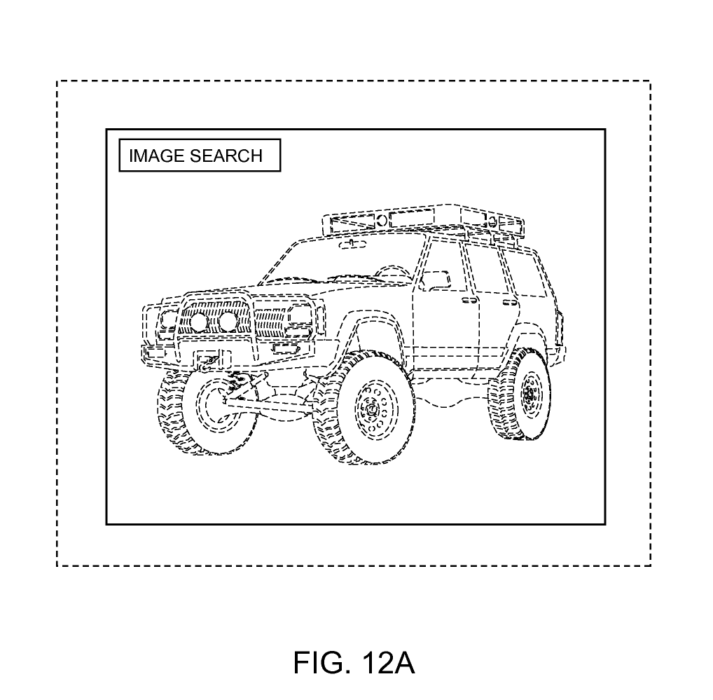

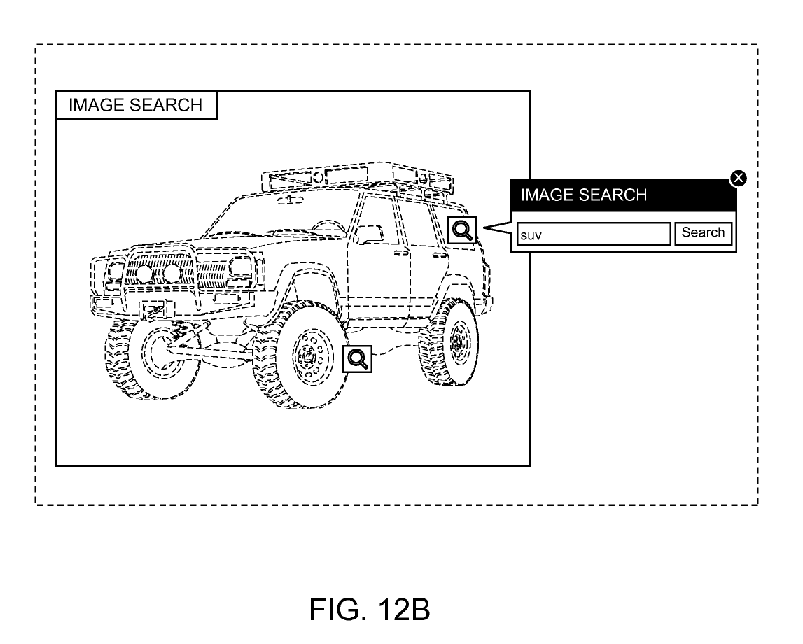

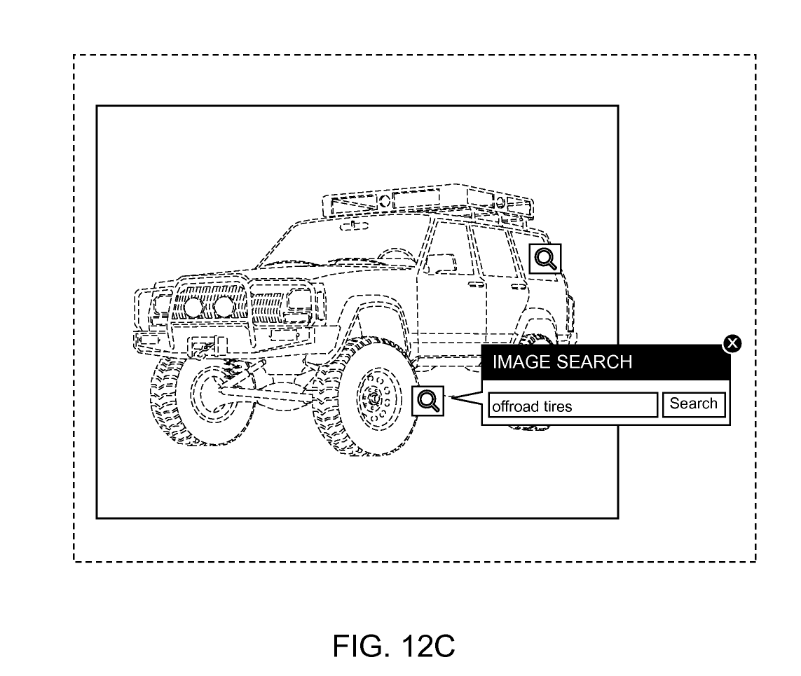

FIGS. 12A-12C are still another exemplary user-interface in accordance with one embodiment presented herein. FIG. 12A shows an image being displayed by the source. As shown, an icon (such as an “IMAGE SEARCH” hot spot, or other indicia) can be provided on the image to give the end-user a “hot spot” to activate the image. When the end-user activates the image (e.g., mouse-over the hot spot or mouse-over any area of the image) multiple indicia may be provided over different objects in the image. If the user activates one indicia, a pre-populated search interface is provided, such as shown in FIG. 12B. If the user activates a second indicia, a different pre-populated search interface is presented to the user, as shown in FIG. 12C. The end-user can then modify the pre-populated search interface, or simply accept the pre-populated search interface, and use the search interface to conduct an Internet search of the subject matter within the image.

The presented methods, or any part(s) or function(s) thereof, may be implemented using hardware, software, or a combination thereof, and may be implemented in one or more computer systems or other processing systems. For example, the presented methods may be implemented with the use of one or more dedicated ad servers. Where the presented methods refer to manipulations that are commonly associated with mental operations, such as, for example, receiving or selecting, no such capability of a human operator is necessary. In other words, any and all of the operations described herein may be machine operations. Useful machines for performing the operation of the methods include general purpose digital computers, hand-held mobile device or smartphones, computer systems programmed to perform the specialized algorithms described herein, or similar devices.

### Computer Implementation.

FIG. 6 is a schematic drawing of a computer system used to implement the methods presented herein. In one embodiment, the invention is directed toward one or more computer systems capable of carrying out the functionality described herein. An example of a computer system 600 is shown in FIG. 6. Computer system 600 includes one or more processors, such as processor 604. The processor 604 is connected to a communication infrastructure 606 (e.g., a communications bus, cross-over bar, or network). Computer system 600 can include a display interface 602 that forwards graphics, text, and other data from the communication infrastructure 606 (or from a frame buffer not shown) for display on a local or remote display unit 630.

Computer system 600 also includes a main memory 608, such as random access memory (RAM), and may also include a secondary memory 610. The secondary memory 610 may include, for example, a hard disk drive 612 and/or a removable storage drive 614, representing a floppy disk drive, a magnetic tape drive, an optical disk drive, flash memory device, etc. The removable storage drive 614 reads from and/or writes to a removable storage unit 618 in a well known manner. Removable storage unit 618 represents a floppy disk, magnetic tape, optical disk, flash memory device, etc., which is read by and written to by removable storage drive 614. As will be appreciated, the removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 614, removable storage units 618, 622, data transmitted via communications interface 624, and/or a hard disk installed in hard disk drive 612. These computer program products provide software to computer system 600. Embodiments of the present invention are directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the presented methods. Accordingly, such computer programs represent controllers of the computer system 600. Where appropriate, the processor 604, associated components, and equivalent systems and sub-systems thus serve as “means for” performing selected operations and functions.

In an embodiment where the invention is implemented using software, the software may be stored in a computer program product and loaded into computer system 600 using removable storage drive 614, interface 620, hard drive 612, or communications interface 624. The control logic (software), when executed by the processor 604, causes the processor 604 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

In another embodiment, there is provided a computer-readable storage medium, having instructions executable by at least one processing device that, when executed, cause the processing device to: (a) receive an image from a source; (b) analyze the image to identify the subject matter within the image; (c) generate a search tag based on the subject matter within the image; and (d) send the search tag to the source. The computer-readable storage medium may further comprise instructions executable by at least one processing device that, when executed, cause the processing device to: identify positional information of a first object in the image; generate a first search tag based on the first object; link the positional information of the first object to the search tag based on the first object; identify positional information of a second object in the image; generate a second search tag based on the second object; link the positional information of the second object to the search tag based on the second object; and send the first search tag and the second search tag, and respective positional information, to the source. The computer-readable storage medium may further comprise instructions executable by at least one processing device that, when executed, cause the processing device to: generate contextually relevant content based on the search tag; and send the contextually relevant content to the source. The computer-readable storage medium may further comprise instructions executable by at least one processing device that, when executed, cause the processing device to: conduct an Internet search based on the search tag; and send the Internet search results to the source.

In another embodiment, there is provided a computer-readable storage medium, having instructions executable by at least one processing device that, when executed, cause the processing device to: display a digital image on a web browser; and upon a web user's activation of the image, providing a pre-populated search interface. The computer-readable storage medium may further comprise instructions executable by at least one processing device that, when executed, cause the processing device to provide a hyperlink proximate to the search interface, wherein the hyperlink is generated based on an object within the image. The computer-readable storage medium may further comprise instructions executable by at least one processing device that, when executed, cause the processing device to display an advertisement creative proximate to the search interface, wherein the advertisement creative is selected based on an object within the image. The computer-readable storage medium may further comprise instructions executable by at least one processing device that, when executed, cause the processing device to display content specific advertising proximate to the search interface, wherein the content specific advertising is generated based on an object within the image. The computer-readable storage medium may further comprise instructions executable by at least one processing device that, when executed, cause the processing device to display content specific information proximate to the search interface, wherein the content specific information is generated based on an object with the image. The computer-readable storage medium may further comprise instructions executable by at least one processing device that, when executed, cause the processing device to: analyze the image to identify one or more objects within the image; generate a search tag based on the one or more objects within the image; and pre-populate the search interface with the search tag.

### Additional Embodiments

In another embodiment, there is provided a method comprising: (a) steps for receiving an image from a source, which may include step 301 and equivalents thereof; (b) steps for analyzing the image to identify the subject matter within the image, which may include step 302 and equivalents thereof; (c) steps for generating a search tag based on the subject matter within the image, which may include step 303 and equivalents thereof; and (d) steps for sending the search tag to the source, which may include step 304 and equivalents thereof. In another embodiment, the method may further include steps for: identifying positional information of a first object in the image; generating a first search tag based on the first object; linking the positional information of the first object to the search tag based on the first object; identifying positional information of a second object in the image; generating a second search tag based on the second object; linking the positional information of the second object to the search tag based on the second object; and sending the first search tag and the second search tag, and respective positional information, to the source, all of which may include step 400-404 and equivalents thereof. The methods may further includes steps for generating contextually relevant content based on the search tag; and sending the contextually relevant content to the source, which may include step 501-515 and equivalents thereof.

In yet another embodiment, there is provided a computer-based search interface, comprising: (a) means for receiving an image from a source, which includes a network interface, file transfer system, or systems equivalent thereto; (b) means for analyzing the image to identify the subject matter within the image, which includes crowdsourcing and/or image recognition engines, or systems equivalent thereto; (c) means for generating a search tag based on the subject matter within the image, which includes crowdsourcing and/or image recognition engines, or systems equivalent thereto; and (d) means for sending the search tag to the source, which includes a network interface, file transfer systems, or systems equivalent thereto. The computer-based search interface may further include means for: identifying positional information of a first object in the image; generating a first search tag based on the first object; linking the positional information of the first object to the search tag based on the first object; identifying positional information of a second object in the image; generating a second search tag based on the second object; linking the positional information of the second object to the search tag based on the second object; and sending the first search tag and the second search tag, and respective positional information, to the source, all of which may include crowdsourcing, image recognition engines, and network interface, or system equivalent thereto. The computer-based search interface may further include means for: generating contextually relevant content based on the search tag and/or conducting an Internet search based on the search tag, both of which may include search engines, ad servers, database search protocols, or systems equivalent thereto.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

1. A computer-implemented method of automatically providing contextually relevant document search results proximate to an image displayed on a digital content platform, the method comprising:
(a) receiving notification that an end-user has activated the image on the digital content platform;
(b) providing the image to a crowdsource network for analysis, wherein the crowdsource network identifies the subject matter within the image and generates a search query that is contextually relevant to the subject matter within the image;
(c) receiving the search query from the crowdsource network;
(d) conducting a search for contextually relevant documents based on the search query received in step (c), wherein the contextually relevant documents are selected from the group consisting of: advertisements; text documents; hyperlinks; images; and Internet search results; and
(e) sending the search query and the contextually relevant documents to the digital content platform for display in a search interface proximate to the image.

2. The computer-implemented method of claim 1, wherein step (b) further comprises:
(1) identifying positional information of a first object in the image;
(2) generating a first search tag based on the first object;
(3) linking the positional information of the first object to the first search tag;
(4) identifying positional information of a second object in the image;
(5) generating a second search tag based on the second object;
(6) linking the positional information of the second object to the second search tag; and
(7) sending the first search tag and the second search tag, and respective positional information, to the digital content platform.

3. The computer-implemented method of claim 2, further comprising:
submitting the image to a computer-implemented image recognition engine for performing steps (1)-(7).

4. The computer-implemented method of claim 2, wherein steps (1)-(7) are performed by the crowdsource network.

5. The computer-implemented method of claim 1, wherein the search query is in the form of an informational query, a navigational query, a transactional query, a connectivity query, or a syntax-specific standardized query.

6. The computer-implemented method of claim 1, wherein the search query is used to pre-populate a search engine interface.

7. The computer-implemented method of claim 1, wherein the end-user's activation of the image is a mouse-over event.

8. A computer-implemented method of automatically providing an Internet search query, pre-populated in a search engine interface displayed proximate to an image on a digital content platform, comprising:
(a) receiving notification that an end-user has activated the image on the digital content platform;
(b) providing the image to an image analysis engine, wherein the image analysis engine generates a search query;
(c) receiving the search query from the image analysis engine; and
(d) sending the search query to the digital content platform such that the search query is provided to the end-user in a pre-populated search engine interface.

9. A non-transitory computer-readable storage medium for automatically providing contextually relevant document search results proximate to an image displayed on a digital content platform, the computer-readable storage medium comprising:
instructions executable by at least one processing device that, when executed, cause the processing device to
(a) receive notification that an end-user has activated the image on the digital content platform;
(b) provide the image to a crowdsource network for analysis, wherein the crowdsource network identifies the subject matter within the image and generates a search query that is contextually relevant to the subject matter within the image;
(c) receive the search query from the crowdsource network;
(d) conduct a search for contextually relevant documents based on the search query received in step (c), wherein the contextually relevant documents are selected from the group consisting of: advertisements; text documents; hyperlinks; images; and Internet search results; and
(e) send the search query and the contextually relevant documents to the digital content platform for display in a search interface proximate to the image.

10. A non-transitory computer-readable storage medium for automatically providing an Internet search query, pre-populated in a search engine interface displayed proximate to an image on a digital content platform, the computer-readable storage medium comprising:
instructions executable by at least one processing device that, when executed, cause the processing device to
(a) receive notification that an end-user has activated the image on the digital content platform;
(b) provide the image to an image analysis engine, wherein the image analysis engine generates a search query;
(c) receive the search query from the image analysis engine; and
(d) pre-populate a search engine interface, displayed on the digital content platform, with the search query.

11. The non-transitory computer-readable storage medium of claim 10, wherein the digital content platform is a web page.

12. The non-transitory computer-readable storage medium of claim 10, wherein the digital content platform is a mobile application on a mobile device.

13. The non-transitory computer-readable storage medium of claim 12, wherein the end-user activates the image by touching the image on a screen of the mobile device.

14. The computer-implemented method of claim 1, wherein the digital content platform is a web page.

15. The computer-implemented method of claim 1, wherein the digital content platform is a mobile application on a mobile device.

16. The computer-implemented method of claim 15, wherein the end-user activates the image by touching the image on a screen of the mobile device.

17. The computer-implemented method of claim 8, wherein the digital content platform is a web page.

18. The computer-implemented method of claim 8, wherein the digital content platform is a mobile application on a mobile device.

19. The computer-implemented method of claim 18, wherein the end-user activates the image by touching the image on a screen of the mobile device.

20. The non-transitory computer-readable storage medium of claim 9, wherein the digital content platform is a web page.

21. The non-transitory computer-readable storage medium of claim 9, wherein the digital content platform is a mobile application on a mobile device.

22. The non-transitory computer-readable storage medium of claim 21, wherein the end-user activates the image by touching the image on a screen of the mobile device.
